(19) United States
(12) Patent Application Publication
(10) Pub. No.: US 2023/0351252 A1
(43) Pub. Date: Nov. 2, 2023

(54) DECENTRALIZED TRAINING METHOD SUITABLE FOR DISPARATE TRAINING SETS

(71) Applicant: KONINKLIJKE PHILIPS N.V., EINDHOVEN (NL)

(72) Inventors: Ashul Jain, Bangalore (IN); Shreya Anand, Bangalore (IN); Shiva Moorthy Pookala Vittal, Bangalore (IN); Aleksandr Bukharev, Moscow (RU); Richard Vdovjak, Eindhoven (NL); Rithesh Sreenivasan, Bangalore (IN)

(21) Appl. No.: 18/030,175

(22) PCT Filed: Sep. 23, 2021
(86) PCT No.: PCT/EP2021/076139

§ 371 Date: Apr. 4, 2023

Related U.S. Application Data
(60) Provisional application No. 63/089,159, filed on Oct. 8, 2020.

(51) Int. Cl. G06N 20/00

(52) U.S. Cl. CPC G06N 20/00

(57) ABSTRACT

Some embodiments are directed to training a model, e.g., a medical model. The training uses multiple model updates received from multiple client systems. At least some of the multiple client train on training sets that indicate values for different features. The model updates are aggregated in an aggregated model, for which feature weights are obtained. The feature weights provide information on the relative importance of the multiple features for the aggregated model's output.

### TECHNICAL FIELD

The presently disclosed subject matter relates to a computer-implemented server method for training a model, a computer-implemented client method for training a model, a server system for training a model, a client system for training a model, a computer readable medium.

### BACKGROUND

Predicting a likelihood of disease is a useful application of predictive modelling. For example, cardiovascular disease (CVD) is a leading cause of death worldwide and a major public health concern. Several risk prediction models of cardiovascular disease have been developed for different populations in the past decade. For example, a predictive model may take various features as input and produce as output a likelihood, e.g., a probability, that the person corresponding the input feature values is affected or will be affected by the predicted affliction, e.g., cardiovascular disease. Such a prediction can be used for various purposes, e.g., targeting lifestyle interventions, heightened monitoring, e.g., in a hospital setting, and so on.

Conventionally, such models are developed by collecting a large data set and training a model on them. An example of a predictive model is given in U.S. Pat. No. 6,869,802, included herein by reference. In the known model, information was collected that indicates the level of coronary artery disease for a group of 877 individuals, ranging from no disease to severe. Furthermore, values were collected for a range of features, including age, various types of cholesterol levels, and the like. On the data set a stepwise discriminant analysis was performed to obtain a model that predicts the level of coronary artery disease from the feature values. A predictive model is obtained as a result; in this case for coronary artery disease

A problem with this traditional approach is that a complete data set is needed at a central location. Having a central data set makes it easier to ensure the data is uniform and of high quality. Any algorithms to obtain a model from the data can run locally. Unfortunately, the central approach is increasingly difficult, especially as data set sizes continue to grow. Developing predictive models, e.g., to determine the risk of medical conditions requires more data as the sensitivity of the models grows, or as the number of features included grows, etc. For example, privacy concerns make it increasingly harder to collect the needed data at a central location. Especially if the data has to come from different sources, e.g., different hospitals, then this is often a hurdle.

Various technical solutions to this problem have been suggested. For example, in the paper “Communication-Efficient Learning of Deep Networks from Decentralized Data”, included herein by reference, a decentralized training approach is suggested called ‘Federated learning’. In federated learning, mobile phones train a neural network on locally available training data. A shared model is obtained by aggregating locally-computed model updates. Unfortunately, federated learning does not solve all problems that are associated with losing the central setting for training a model. Although in federated learning training algorithms run locally, still a high central control of the process is maintained. For example, locally running software, e.g., ‘apps’, may ensure such control, e.g., to ensure the uniformity of the data. Such a high level of control may not always be feasible.

### SUMMARY

Computationally efficient and privacy-aware solutions for large-scale machine learning problems are ever more important, especially in the healthcare domain due to challenges towards taking data out from hospitals. Federated Learning enables Hospitals to collaboratively learn a shared prediction model without moving data outside the hospitals. However, federated learning still assumes that the data used that the participating sites is highly uniform. Moreover, it is assumed that the models used at the participating sites is the same. In practice, this turns out not to be the case. For example, the training sets available at different site may be disparate, e.g., in different sites different features may be used to make predictions. It would be advantageous to have an improved decentralized training method.

In an embodiment, a model is improved by aggregating model updates of multiple clients. The aggregated model is arranged to receive multiple feature values representing multiple features. The features for which values are allowed by the aggregated model are referred to as the main feature set. Not all clients need to share the main feature set. Not all clients need to have the same feature set. Feature weights are obtained for the aggregated model that represent the relative importance of the multiple features for the aggregated model's output. The feature weights represent information that is not available locally at the clients, and in fact, cannot be computed locally as individual clients may lack the training data to properly assess the aggregated model. The same may hold for the server, e.g., the aggregator, that aggregates the model updates. Nevertheless, the feature weights are important, as they tell in effect which features are worthwhile to start capturing. Accordingly, the server may share information based on the weights to improve the clients. For example, the server may inform the client which feature, which the client currently does not use, the client should start using to improve its local predictions. The server may also send all aggregated feature weights, or a list of the most important ones, regardless whether the receiving client uses the corresponding features or not.

Advantageously, feature weights may be obtained in a decentralized manner. For example, the aggregated model obtained at the server may be distributed to the clients. The client may assess the aggregated model with local training samples, and so derive client feature weights. For example, a client may apply the aggregated model to local training samples and determine which features of the tried training samples were important for the aggregated model's results. The server may aggregate the client feature weights into global feature weights. The latter in effect tell the importance of various features.

Embodiments may be applied to a medical model arranged to receive medical feature values as input and/or to predict a medical condition. Embodiments may also be applied to other types of models, e.g., models predicting a future technical state of a technical system, e.g., an engine, from current sensor values, the history of the system and so on.

The server system and the client system may each be embodied as an electronic device, e.g., a computer. An embodiment of a method may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

An aspect refers to a training system comprising a server system and multiple client systems. An aspect refers to a training method comprising a server method and client method; for example, the training method may be executed distributed over a server system and multiple client systems.

In an embodiment, the computer program comprises computer program code adapted to perform all or part of the steps of an embodiment of the method when the computer program is run on a computer. Preferably, the computer program is embodied on a computer readable medium.

### BRIEF DESCRIPTION OF DRAWINGS

Further details, aspects, and embodiments will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1a schematically shows an example of an embodiment of a training system,

FIG. 1b schematically shows an example of an embodiment of a training system,

FIG. 1c schematically shows an example of an embodiment of a training system,

FIG. 2a schematically shows an example of an embodiment of a server training system,

FIG. 2b schematically shows an example of an embodiment of a server training system,

FIG. 3a schematically shows an example of an embodiment of a client training system,

FIG. 3b schematically shows an example of an embodiment of a feature set,

FIG. 4a schematically shows an example of an embodiment of a training system,

FIG. 4b schematically shows an example of an embodiment of a training system,

FIG. 5 schematically shows an example of an embodiment of a server training method,

FIG. 6 schematically shows an example of an embodiment of a client training method,

FIG. 7a schematically shows a computer readable medium having a writable part comprising a computer program according to an embodiment,

FIG. 7b schematically shows a representation of a processor system according to an embodiment.

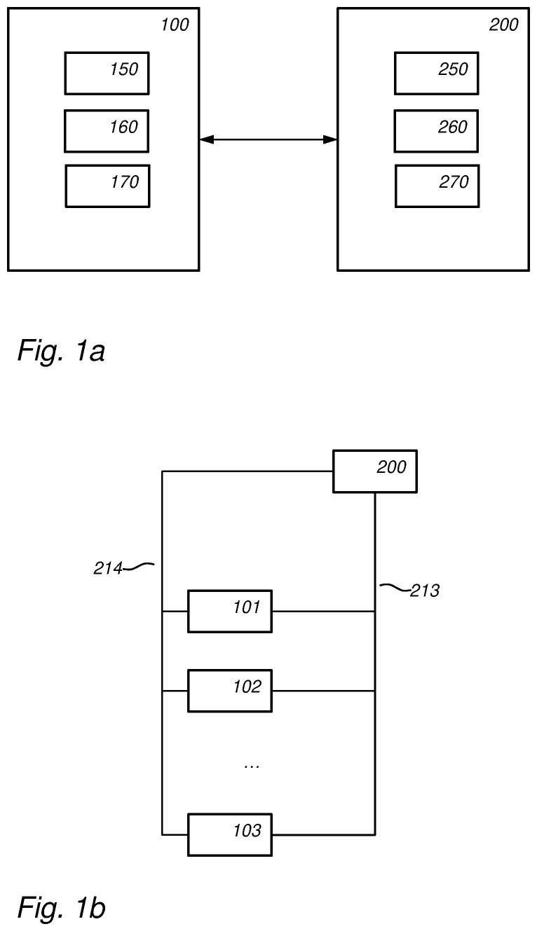

### LIST OF REFERENCE NUMERALS IN FIGS. 1a-4b. 7a-7b

The following list of references and abbreviations is provided for facilitating the interpretation of the drawings and shall not be construed as limiting the claims.
100-103 a client system
150, 250 a processor system
160, 260 a storage
170, 270 a communication interface
200-202 a server system
211-212 a server system
213 model communication
214 feature communication
210 a base training set
231 a training unit
232 an evaluation unit
220 model parameters
222 model aggregator
240 a feature weight determinator
241 feature weights
242 a feature weight aggregator
310 a client training set
311 a client system
320 model parameters
322 model update unit
331 a training unit
332 an evaluation unit
340 a feature weight determinator
341 feature weights
351-353 a feature set
361-364 a feature
400 a server
411 aggregator packages
412 an aggregated model
413 a model explainer
414 a feature distinguisher
415 a feature transfer
421-423 a client
430, 440 a participating site
431, 441 a client model
432, 442 a client prediction
433, 443 a client explainer
434, 444 feature weights
450 a site
451 an aggregated model
452 a prediction
453 an explainer
454 feature weights
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DESCRIPTION OF EMBODIMENTS

While the presently disclosed subject matter is susceptible of embodiment in many different forms, there are shown in the drawings and will herein be described in detail one or more specific embodiments, with the understanding that the present disclosure is to be considered as exemplary of the principles of the presently disclosed subject matter and not intended to limit it to the specific embodiments shown and described.

In the following, for the sake of understanding, elements of embodiments are described in operation. However, it will be apparent that the respective elements are arranged to perform the functions being described as performed by them. Further, the subject matter that is presently disclosed is not limited to the embodiments only, but also includes every other combination of features described herein or recited in mutually different dependent claims.

FIG. 1a schematically shows an example of an embodiment of a training system. Shown in FIG. 1a is a server system 200 and a client system 100. Although only one client system is shown, in a typical embodiment, there is one server system 200 and multiple client systems 100. Having multiple server systems 200 is possibly though.

For example, the client system 100 may be used to locally train a model on a local client training set, and to send model updates for the model to server system 200. Server system 200 may be configured to aggregate the models updates from the multiple clients into an aggregate model. The features used by the multiple clients do not have to be uniform, e.g., do not have to be the same across the multiple clients. Disparate training sets, e.g., training sets that do not use the same feature set, are a problem for existing approaches. Server system 200 and the client systems 100 may cooperate to determine feature weights that indicate which features are important for predictions. This information can be used by client system 100 to further improve its model.

Client system 100 may comprise a processor system 150, a storage 160, and a communication interface 170. Server system 200 may comprise a processor system 250, a storage 260, and a communication interface 270.

Storage 160, 260 may comprise local storage, e.g., a local hard drive or electronic memory. Storage 160, 260 may comprise non-local storage, e.g., cloud storage. In the latter case, storage 160, 260 may comprise a storage interface to the non-local storage. Systems 100 and/or 200 may communicate with each other, internally, with other systems, external storage, input devices, output devices, and/or one or more sensors over a computer network. The computer network may be an internet, an intranet, a LAN, a WLAN, etc. The computer network may be the Internet. The system comprises a connection interface which is arranged to communicate within the system or outside of the system as needed. For example, the connection interface may comprise a connector, e.g., a wired connector, e.g., an Ethernet connector, an optical connector, etc., or a wireless connector, e.g., an antenna, e.g., a Wi-Fi, 4G or 5G antenna.

In systems 100 and 200, the communication interface 170, 270 may be used to send or receive digital data. For example, a client system 100 may send model updates, receive an aggregated model, and send or receive feature weights and/or other feature information. For example, a server system 200 may receive model updates, send an aggregated model, and send or receive feature weights and/or other feature information.

The execution of systems 100 and 200 may be implemented in a processor system, e.g., one or more processor circuits, e.g., microprocessors, examples of which are shown herein. The processor system may comprise a GPU and/or CPU. Systems 100 and 200 may each comprise multiple processors, which may be distributed over different locations. For example, system 100 and 200 may use cloud computing.

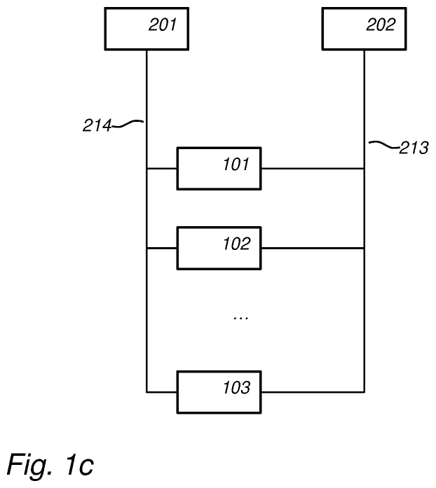

Other figures show functional units that may be implemented as functional units of the processor system. For example, FIGS. 2a-4b may be used as a blueprint of a possible functional organization of the processor system. The processor circuit(s) are not shown separate from the units in these figures. For example, the functional units shown in the figures may be wholly or partially implemented in computer instructions that are stored at system 100 and/or 200, e.g., in an electronic memory of system 100 and/or 200, and are executable by a microprocessor of system 100 and/or 200. In hybrid embodiments, functional units are implemented partially in hardware, e.g., as coprocessors, e.g., neural network coprocessors, etc., and partially in software stored and executed on system 100 and/or 200. One or both of systems 100 and 200 may be implemented as a device. For example, in an embodiment, the client systems are implemented as client devices, while the server system is implemented as a distributed computing system. The server system may also be a device.

Cardiovascular disease (CVD) will be considered herein as a motivating example. CVD is a leading cause of death worldwide and a major public health concern. Several risk prediction models of cardiovascular disease have been developed for different populations in the past decade. However, embodiments may be applied to other medical applications. For example, the model may be a medical model, e.g., receiving medical data as input and/or generating medical data as output. The model may be predictive, e.g., to predict a medical condition, e.g., CVD.

As an example, a Cardiovascular Disease Risk Prediction model is trained on different sites using federated learning. This example model uses logistic regression to train a model. The example model receives values of various features that may be correlated to CVD.

In general, suppose there are n features present for a model and p data samples, the probability of Cardiovascular disease may be based on a predictor vector X obtained by considering each feature, x, and β is the regression coefficient which indicates the relevance of the predictor or the contribution of the predictor on the outcome class. The probability of CVD given predictor vector X may be modelled as

$$P ( CVD \vert X ) = \frac{{e}^{{β}_{0} + {β}_{1} {x}_{1} + ⋯ + {β}_{p} {x}_{pn}}}{1 + {e}^{{β}_{0} + {β}_{1} {x}_{1} + ⋯ + {β}_{p} {x}_{n}}} .$$

The parameters β may be obtained by applying multiple training iterations to a training data set. For example, gradient descent may be used to converge towards parameters β. Many other types of models and training are possible, some of which are further discussed herein.

In an embodiment, the server system, sometimes referred to as the coordinator or aggregator, builds a base model which is arranged to receive as input values for a list of many possible features for a CVD model. The base model is built on this set of features. If the coordinator has a base training set, then initial training may be on this dataset. The base model is then sent across to the multiple client systems. In this embodiment, the clients train on the same base model. The clients train the base model on the data that they have available locally. It is not needed that the clients use the same features. If a client does not have data for a particular feature, then that feature is not used at that client. A model update is sent from a client to the server system. The model update may comprise information on how the base model should be modified to improve its prediction for the local data. For example, model updates may comprise an updated model; a model update may comprise parameter updates, information that indicates how a parameter should be changed, e.g., increased, decreased or replaced; a model update may comprise a training information, e.g., a gradient.

The server system can use the model updates to compute an aggregated model from the model updates. The additional training on local data, possibly over multiple rounds, increases the quality of the aggregated model.

Interestingly, weights may be computed for the features. For example, a model update may also comprise weights for each feature. Weights for missing features may be set to zero, or the like, as these features are not captured. The feature weights received at the server system may also be aggregated, e.g., averaged.

For example, techniques like federated averaging may be used for aggregation. In an embodiment, missing feature weights are not considered for aggregation, e.g., not included in an average. For example, consider C1, C2 and C3 as three separate clients; f1, f2 as features, A, B, C, D as coefficients. For simplicity assume each feature is weighted with a single coefficient, e.g., as in logistic or linear multivariate regression. Then models updates received from a client may be represented, say, as:
C1: A*f1 (f2 feature is missing),
C2: B*f2 (f1 feature is missing),
C3: C*f1+D*f2.

In other words, client C1 sends an updated parameter for feature f1, but not for feature f2, as the latter is not used by C1. C3 on the other hand sends updated parameters for both features. The aggregate model may be represented as (A+C)*f1/2+(B+D)*f2/2. To compute an aggregate parameter for a feature only those model updates are taken into account that correspond to a client that uses said feature.

In this example, the clients send the updated values of parameters, but instead the client may send deltas compared to previous values of the parameters. For example, client C1 may send (A-A′), in which A′ represent a previous common value of the parameter for f1. As will be further expanded upon herein, this aggregation example can be varied in many ways, e.g., to more parameters, features, different types of averaging and so on.

In this way, information is uncovered that could not be individually—neither the base training set nor a client data set may be sufficient, e.g., sufficiently large or varied, etc., to uncover the true importance of some features, e.g., the feature weights. However, once this information is collated the clients can individually improve their models, e.g., automatically or manually as the case may be. As an example, below is a sample list of coefficients received after training at a particular client for the CVD use case. The data is obtained from a simulation of the system; although the data does not represent true weights for CVD disease, it is representative for an embodiment. The numbers were obtained with LIME, but any other explainability tool may be used. In the table below the various sites, e.g., the client systems, report to the server system, e.g., the aggregator. Note that some clients do not use some feature, which is indicated with a weight ‘0’. For example, clients 1 and 4 do not include the feature ‘Smoking’ in their client training set; for example, this data may not be captured at the corresponding sits.

| | | | | | | Aggre- |
|---|---|---|---|---|---|---|
| | | | | | | gated |
| Parameter | Site1 | Site2 | Site3 | Site4 | Site5 | Weights |
| Age | 0.347 | 0.245 | 0.143 | 0.041 | −0.061 | 0.143 |
| Hypertension | 0.285 | 0.121 | 0.103 | 0.127 | 0.251 | 0.177 |
| Diabetes | 0.284 | 0.184 | 0.193 | 0.003 | −0.086 | 0.116 |
| Smoking | 0 | 0.245 | 0.145 | 0 | 0.112 | 0.167 |
| Exercise | 0.347 | 0 | 0.245 | 0.018 | 0.154 | 0.191 |
| Regime | | | | | | |
| body mass | −0.042 | 0.018 | 0 | 0.154 | 0.052 | 0.046 |
| index | | | | | | |
| Gender | 0.245 | 0.156 | 0.067 | −0.022 | 0.35 | 0.159 |
| Total | 0.164 | 0 | 0.108 | 0.01 | 0.448 | 0.182 |
| cholesterol | | | | | | |
| blood | 0.019 | 0.34 | 0.118 | −0.03 | 0.644 | 0.218 |
| pressure | | | | | | |
| Retinopathy | 0.141 | −0.154 | −0.113 | −0.01 | 0.446 | 0.062 |
| High-density | 0 | 0.141 | 0.122 | 0.245 | 0.125 | 0.158 |
| lipoprotein | | | | | | |
| cholesterol | | | | | | |

The server system computes aggregated weights from the feature weights reported by the client systems. In this example, aggregated weights are calculated by averaging the weights for each feature. Sites that do not consider a particular feature are left out, so that the aggregated weight is computed only from sites that use the corresponding feature. For example, the aggregated weight for Smoking is the sum of the three reported feature weights divided by three, as there are three sites that consider this feature. One could regard this as a weighted average in which sites that do not use a particular feature are given weight 0.

Features that have an aggregated weight above a threshold are considered important. For example, in this example one may take the threshold as 0.1, so that all features except body mass index and retinopathy are considered important. In particular, the feature weight for smoking is high (0.167) after aggregation indicating the importance of this feature for model training and inference. Communicating this information with Site1 and Site4 shall help to capture data for missing features in future. On the other hand, the feature body mass index has an aggregated weight of 0.046 which is below the threshold. Although site 3 does not record this feature, there is no need to communicate to site 3 that it could improve its model by incorporating this particular feature in their system. CVD is an example of a disease that can be predicted from feature values.

The predicting model can be learnt locally and moreover it can be discovered through a decentralized analysis which features are important. Predicting CVD is just one example of a model for which decentralized feature analysis is possible. For example, other medical predictive models may be trained in this manner. For example, the server system and client systems configured as herein can also be applied to other data fields. For example, in an embodiment, engine emissions may be estimated from various feature values, including, e.g., speed, vehicle age, car model, number of cylinders, cylinder volume, cylinder pressure, and so on. Participants to the training of the model may not agree on the features that should be incorporated in the model, but using an embodiment, this can be answered in a distributed manner. For example, a base model can be refined by locally training on sensor data obtained locally in cars, without having to upload the data. In an embodiment, one or more feature values that are input to the model are obtained from a sensor. For example, blood pressure, blood glucose level, cylinder pressure, speed and so on, may be measured by a blood pressure sensor, blood glucose level sensor, cylinder pressure sensor, speed sensor, respectively. The sensors may be incorporated in the client systems, and/or the client system may be provided with an interface to receive sensor signals.

FIG. 1b schematically shows an example of an embodiment of a training system. Shown in FIG. 1b is a server system 200 and multiple client systems; shown are client systems 101, 102, and 103. The server system and client system exchange various messages, e.g., digital messages, e.g., over a computer network. FIG. 1b shows model communication 213 related to the model and feature communication 214 related to the weights.

For example, model communication 213 may comprise distributing a trained base model from the server system to the multiple client devices, receiving at server system 200 multiple model updates from the multiple client devices, and distributing the aggregated model to the multiple client devices. Some of these are optional. For example, if some training schemes do not require a base model, and so no base model distribution is required. For example, distributing the aggregated model is not needed, e.g., if only a single training round is performed, or only a single training round with this set of client systems.

For example, feature communication 214 may comprise receiving at server system 200 multiple client feature weights for the aggregated model from the multiple clients, and sending a signal to the corresponding client device indicating a particular feature. The receiving feature weights from the client systems can be avoided so that this communication is optional; for example, if the base training set is sufficiently rich, the feature weights can be determined at the server system. For example, the server system may keep a hold-out part of the training data set to assess feature weights. The hold-out set is not used to train the model, nor shared with the client systems.

FIG. 1c schematically shows an example of an embodiment of a training system. The training system shown in FIG. 1c is a variant of the embodiment described with respect to FIG. 1c. In FIG. 1c, system 200 is distributed over feature sub-system 201 and a model sub-system 202. For example, feature sub-system 201 may be configured for feature weight related tasks, e.g., to receive feature weights from the multiple client systems, aggregate them and communicate important features. For example, model sub-system 202 may be configured for model related tasks, e.g., to train and distribute the base model, aggregate model updates and so on.

Sub-systems 201 and 202 need not be in communication with each other. In an embodiment, these sub-systems can operate independent of each other. In an embodiment, there may be a further sub-system to which both sub-systems 201 and 202 report.

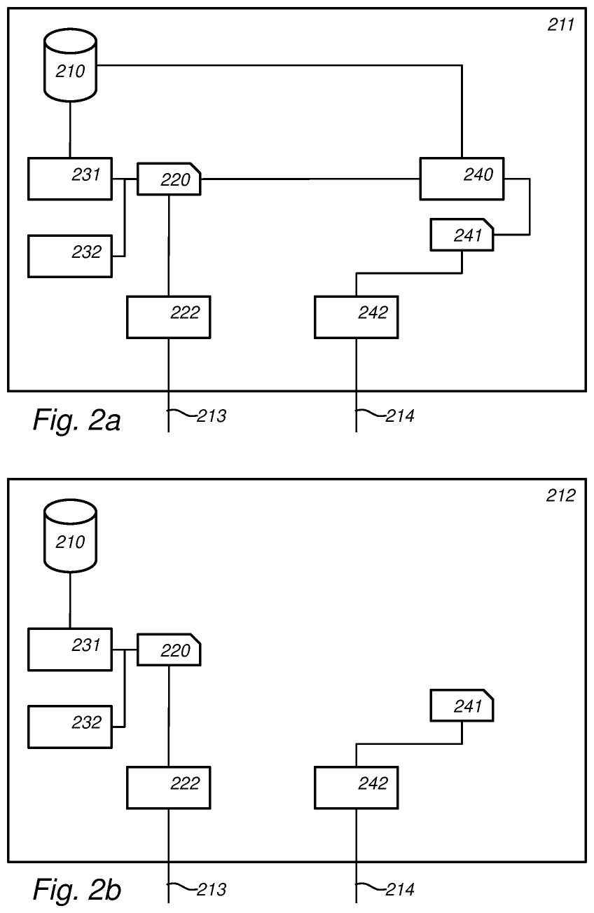

FIG. 2a schematically shows an example of an embodiment of a server training system 211. For example, training system 211 may be configured for a distributed training scheme, e.g., distributed over multiple client systems. For example, server system 211 and the client system may be implemented as systems 200 and 100 respectively. For example, server system 211 may be implemented as systems 201 and 202. For example, the client systems may be configured as in an embodiment, e.g., as discussed with respect to FIG. 3a, etc. Training system 211 may be configured to obtain feature weights for features that are used by one or more client systems, but not by all. Training system 211 may communicate to a client system that does not use some particular feature, that incorporating that feature may improve the accuracy of its model.

For example, the model that is trained may be a medical model, e.g., arranged to receive medical feature values as input and/or to predict a medical condition. This is not necessary though, for example, the model may be related to a different field. For example, the model may be configured to receive sensor values representing a technical feature in a physical system, e.g., a device, e.g., an engine, etc.

The client systems with which server system 200 is in contact may have a local model. These client models may be similar, but they need not be identical. For example, their corresponding feature sets may be overlapping but not identical. Preferably, the underlying model configuration is the same, but this is not strictly necessary.

For example, the client systems may be associated with hospitals. For example, the hospitals may train their models on the data that is available to them using the features that are relevant for their clinical context or which are more easily available to them. Although a hospital may have access to additional features there may be good reasons why they are not used in their model. For example, data may be available but in need of digitization before it can be accessed. For example, an additional feature may be obtained from available data but may require a domain expert, e.g., a doctor, to evaluate the available data. For example, a doctor may need to evaluate a medical image to make an additional feature digitally accessible. A hospital may be willing to invest in curating the values corresponding to a particular feature but may first need some assurance that the additional feature will help.

Federated learning and other decentralized training methods make it easier to train a model on data that is only locally available. But these known methods still assume that the data is uniform, that is that all of the multiple clients use the same features. In practice, it was found that this is not always the case. For example, hospitals may be willing to cooperate, and to train a superior model by contributing model updates to an aggregated model, but in practice this is not directly possible because of differences in the features sets that are used.

In an embodiment, server system 211 is configured to train a base model on a base training set. The base model may serve as a starting point for the local training done by the clients. The base model is distributed to the multiple client devices. For example, in an embodiment, server system 211 comprises a base training set 210, e.g., in the form of a base training set storage. Server system 211 may also comprise a training unit 231. Training unit 231 is configured to train the base model parameters on the base training set. Typically, the training unit 231 iteratively applies training rounds appropriate for the chosen model. For example, training unit 231 may iteratively apply backpropagation to examples in the base training set. The trained base model may be the initial values for model parameters 220. Model parameters 220 may be distributed to the multiple clients as a starting point for their decentralized training. For example, the clients may send model updates that are updates with respect to the base model.

Not all of the client systems will use the same set of features. One way to accommodate this is, is to arrange the base model with many inputs. For example, the base model may be configured to allow a feature value for any feature in a main set of features. The main set is chosen so that all of the features collectively used by the multiple clients is contained in the main set. Features in the main set may be identified with a feature ID. For example, the feature ID may be taken from a standardized encoding scheme for medical data, e.g., LONIC or HL7.

The base model is trained on the base training set. Preferably, the base training set contains examples all of the features of the main set, but this is not necessary. In any case, some of the clients will not have data for all of the features in the main feature set. There are various ways to use a model without having feature values for all of the feature that can occur at the input; Some of which are further explained herein. These techniques may be used by a client system or a server system that needs to apply the model to data that does not have a feature value for one or more of the feature inputs of the model, e.g., the base model.

For example, in an embodiment, the main features set is larger in size than the features used by at least one client system, e.g., the main feature set is at least 1.5 times the size of a client feature set. For example, in an embodiment, the main feature set may have, say, 30 features, while a client device may use only 20 features. Larger feature sets are also possible. In an embodiment, the main feature set is much larger than the feature set of some of the clients.

Using a base model as starting point has the advantage that the models that the clients develop are closer together as they start from the same starting point. Using a base model also has the advantage that model updates can be sent as parameter deltas instead of having to send the full parameters. However, using a base model is not needed. For example, if the model is linear or closer to linear, the model themselves can be meaningfully averaged without starting the clients from a base model. If no base model is trained, then trainer 231 is not needed either. System 211 may comprise an evaluation unit 232 so that server 211 can be used to evaluate the model; for example, evaluation unit 232 may be used by trainer 231. Server 211 may itself be used

In an embodiment, server system 211 may be configured to receive multiple model updates from multiple client devices and to aggregate the multiple model updates to obtain an aggregated model. For example, server system 211 may comprise a model aggregator 222 configured to receive the model updates and to aggregate them. A model update represents the model parameters improved in training iterations executed by a client device on a corresponding client training set. For example, a client device may receive a model, e.g., the base model, from the server system 211 and continue to further train it on locally available training data, e.g., using the same type of training algorithm as used by training unit 231. Part of the training samples that are used by one or more client systems will miss some of the features that could be entered into the model, e.g., that are in the main feature set.

In an embodiment, the aggregated model and/or the base model is arranged to receive as input feature values for a main feature set. The training samples at a client system indicate values for features in the main feature set. They may have more information, which is not used by the base or aggregated model. At least one of the client systems do not use all features in the main feature set. For example, at least two of the client systems use a different subset of the main feature set.

The client systems train on client training data that may only be available to that particular client. A client training set may however not be complete, in the sense that it has feature values for all of the features in the main feature set. This is the case for at least some of the multiple client training sets. For example, there may be at least two client training sets that indicate feature values for different features.

Server 211, e.g., aggregator 222 may be configured to receive model updates and to aggregate them. For example, aggregating model updates may be to average them, possibly a weighted average, e.g., weighted with respect to the size of the corresponding client training set. For example, the aggregating may use a known aggregation algorithm, e.g., as described in the background.

Once the model updates have been aggregated in the model, the model parameters 220 may be updated. The model represented by the model parameters is now trained on more data than is available in base training data set 210. If desired, the aggregated model can be distributed to the multiple client devices. For example, the server system and client systems may perform multiple iterations of locally training the model, sending model updates from multiple client devices to the server system, aggregating the multiple model updates to obtain a further aggregated model, and distributing the further aggregated model.

The model updates may comprise the client model parameters themselves. The model updates may comprise the difference between the client model parameters and the previous iteration of the model, e.g., the base model. Aggregating may comprise averaging the model updates. In an embodiment, aggregating is not done by averaging the parameters but by incorporating selected client models into an ensemble model. For example, in an embodiment aggregating comprises selecting two or more of the multiple model updates and configuring an ensemble model from the selected model updates. The ensemble model may comprise a combining part to combine the model outputs of the models in the ensemble. The ensemble model may use boosting algorithm to combine model outputs, e.g., AdaBoosting.

In an embodiment, server 211 is configured to obtain feature weights for the features used by the aggregated model. The feature weights represent the relative importance of the multiple features for the aggregated model's output. There are at least two ways to obtain feature weights, which can also be combined.

For example, feature weights can be determined locally at server system 211. For example, system 211 may comprise a feature weight determinator 240. Feature weight determinator 240 may apply an algorithm to determine feature weights, e.g., an explainability algorithm, to all or part of the base training set. This has the advantage that feature weights can be computed locally without network overhead, etc. Feature weights can be quickly available, soon after a new aggregated model becomes available. However, this approach will only work well if the base training set is relatively rich, in particular, features that are missing in the base training set may not be evaluated well.

Another approach to obtain feature weights, is to obtain feature weights from the multiple clients. For example, in an embodiment, obtaining feature weights for the aggregated model comprises receiving multiple client feature weights for the aggregated model determined by multiple clients and aggregating the client feature weights. For example, server system 211 may aggregate the model updates in an aggregated model, e.g., new values for model parameters 220. The aggregated model is then distributed to client systems, e.g., to the multiple client systems.

Locally, at the multiple client systems the aggregated model is installed as the new model. Each client system can assess the new model for the training data that is locally available. In particular, a client system can determine feature weights for the aggregated model. The client system may use the same algorithm for doing so as server system 211, e.g., as feature weight determinator 240. For example, a weight feature algorithm may be applied, e.g., an explainability algorithm, to all or part of the client training set. The locally determined weight features are sent from the client system to the server system. At the server system they may be aggregated, e.g., using an average, e.g., a weighted average. For example, system 211 may comprise a feature weight aggregator 242.

For example, the weighing may be proportional to the number of training samples used for assessing a feature weight. For example, the averaging may be done only over those client systems that use a particular feature. For example, if only 10 out of 15 client devices use a particular feature, the average may be taken over 10 feature weights, e.g., without including weights of 0 for the 5 client systems that do not use the feature.

The average used to aggregate feature weights may be an arithmetical average. Other types of averaging may also be used. For example, instead of the Arithmetic mean, a power mean may be used, e.g., the root-mean square, also known as the quadratic mean. Instead of a power of 2, higher powers may be used. An advantage of using a power mean is that individual high values are emphasized; this may of be of advantage if the feature has little weight with many client systems that use it. A consequence may be that a feature weight that is significant at one client system is diluted too much by small feature weights found at other client devices. The latter may happen for example, if the feature is used in few client systems and/or in few training samples at those client systems.

The feature weights obtained by server 2111, e.g., as determined locally and/or aggregated from or with client feature weights may be used to select which features are important for the model outputs, e.g., for the variable that is modelled, e.g., a disease prediction, a sensor prediction, etc. For example, server 211 may send the feature weights for the aggregated model to the client systems. At the client systems this information may be used to improve the local model, e.g., by changing the data that is collected, and thus by adding one or more features to the client training data. This does not necessarily have to imply that existing client training data needs to be extended with the new feature; instead one could use the new feature for new training samples that are added to the client training set.

The feature weights represent a relative importance of the multiple features for the aggregated model's output. Accordingly, adding features with a high feature weight, e.g., above a threshold is expected to improve predictions. One could also use the opposite approach, e.g., stop adding recording feature values for features that have little impact on the predictive capacity of the model.

In an embodiment, server 211 can select a client device which does not use a particular feature but which feature is important, e.g., has a weight above a threshold. For example, server 211 can determine which features are not used by a client device as this may be indicated in the client's communication. For example, a feature weight may be 0, or may have a value indicating that it is not used.

Server 211 is configured to select one or more features that are important, for example, that have a feature weight above a threshold. The selection can also be relative, for example, the top-k, say top-10, features for some number k may be selected. For example, the top k%, say the top 10%, features may be selected for some percentage k. In this embodiment, a client system may thus receive a message that indicates that the client is not using a particular feature, but that it is advised to so as it will likely improve the predictions that can be obtained at the client system.

For example, consider a hospital that does not record the feature smoking when making predictions for CVD. After aggregation, it may turn out that not recording this feature impairs the predictive power that that hospital can achieve. The information that smoking is an important feature is not available at that hospital and cannot easily be obtained locally, as the feature is not recorded there, and so will not show up in a statistical analysis of its data. At server 211, e.g., by determining feature weights and/or aggregating feature weights of other client systems this knowledge is available, e.g., the information that smoking is an important factor to consider when predicting CVD. Accordingly, the server system may send a message to this particular client device indicating that smoking is an important feature. As a result, the corresponding hospital may change its policy and start recording this feature. It may even be the case that the information is available in some system of the hospital, e.g., a database with recorded forms or the like, but that the information is not included in this hospital's modelling. In that case, a gain in predictive power can be obtained relatively easily by making the information available to the model. Accordingly, using an embodiment makes important information available that cannot be obtained locally.

In an embodiment, feature weights for the aggregated model are obtained by combining client feature weights, e.g., feature weights that are computed locally using the client training set. The server could add its own set of feature weights by computing feature weights for the base training set. Using a base training set is not necessary for determining feature weights, as one could only use client feature weights.

For example, in an embodiment, an aggregated model is distributed to the client systems. All or part of the client systems compute feature weights for the aggregated model and send the feature weights to server 211. Server 211 may determine the aggregated feature weights from the multiple client feature weights. The aggregated feature weights may also be referred to as the global feature weights. For example, the client feature weights may be averaged. In an embodiment, a feature weight is aggregated by only considering the feature weights of client systems that use that feature. The latter has the advantage that a feature weight that is used at only a few client systems is diluted to much by the zero feature weights of client systems that do not use it. Before making a recommendation that a feature weight is important, the server may verify that a sufficient number of training samples were used to determine the feature weight. For example, the client systems may report not only the feature weight but also how many training samples indicate a value for that particular feature. This number may also or instead be used for weighing an average.

The relative importance of features, e.g., expressed in a number such as the feature weight may be computed by applying the model, e.g., the aggregated model to a training sample and determining the feature weight for the sample, e.g., the relative importance of a feature for this particular training sample. A feature weight can be computed by aggregating multiple sample feature weights. The aggregating of sample feature weights can be done at a client system, e.g., to obtain a client feature weight, which may be an aggregation of multiple sample feature weights, of training samples on that client system. The client feature weights can then be further aggregated at the server. On the other hand, the client system may send its sample feature weights to the server so that the server directly aggregated the sample feature weights.

A sample feature weight may be computed by varying one of the feature values. The sample feature weight may indicate whether the model output changes, or how much a feature needs to be varied before the model output changes, etc.

A particular good source of obtaining sample feature weights is by applying a so-called explainability algorithm to the training sample and model. The examinability algorithm indicates which features where important for the model to reach its conclusion. An explainability algorithm may also directly apply to the model and determine feature weights from it. Explainability algorithms are sometimes referred to as interpretability algorithms. For example, an explainability algorithm that may be used is LIME, e.g., as described in the paper “Why Should I Trust You?” Explaining the Predictions of Any Classifier' by Marco Tulio Ribeiro, Sameer Singh and Carlos Guestrin, included herein by reference; For example, algorithm 1 may be applied. For example, an explainability algorithm that may be used is SHAP, e.g., as described in the paper “A Unified Approach to Interpreting Model Predictions”, by Scott M. Lundberg and Su-In Lee, included herein by reference.

For example, in an embodiment, a client system may select one or more training samples from its client training set. For example, the selection may be all training samples or a subset, e.g., a random subset. The client system may apply its algorithm to selected training samples, e.g., an explainability algorithm, and obtain sample feature weights, indicating the importance of the features for the selected training samples. The sample weights can be combined into client feature weights, which in turn can be combined into aggregated feature weights. The latter may be done by server 211. Combining may be done by a combining function, e.g., an average function.

In an embodiment, server 211 determines a base model, distributes the base model, computes an aggregated model and aggregated feature weights. The aggregated weights provide important feedback for the client systems. The process can also be iterated, for example, the aggregated model may be distributed after which a further aggregated model is determined and further aggregate feature weights.

In an embodiment, the base model (if used) and the aggregated model allow more feature values at its input for a main feature set which may be larger, and even much larger than the features sets used by the client training sets, or possibly even larger than the base training set. This problem may be resolved in various ways.

To apply a model to a training sample that does not indicate a feature value for a particular feature, one may input a substitute value. For example, the substitute value may be an interpolated value. The interpolated value may be an average value known for that value, possibly with some noise added to it. If the feature is used in some other training sample the missing value may be interpolated from them, e.g., use an average of k-nearest neighbors. An interpolated value may be specific to a client. For example, consider a children's hospital that does not use the feature ‘age’. In this situation it would be better to substitute an average age of a child in that hospital than to substitute and average age over a potentially much wider patient population.

The substitute value may be a random value in an interval. The substitute value may be selected again when the training sample is used again in a next training iteration. In an embodiment, the substitute value is chosen so that the feature weights for that feature will converge to zero, e.g., the feature is not important for the prediction—as it should be since the data is actually not available.

Another approach is to extend the model with additional inputs that indicate whether or not a value is available, at the input of the model, for a particular value. This approach has the advantage that the model can learn how to deal with a missing value itself. For example, even for features that are available in a training sample, the model may be trained on a training sample in which a feature is removed for some training iterations. This approach is better for situations in which versatile models are used and relatively large amounts of training data. For example, a model may comprise a neural network. Some input lines of the neural network may represent feature values, while others input lines represent the availability of a value. For example, an input x to the neural network may be used to input a feature value, e.g., smoking or non-smoking, while an input y may indicate whether or not the input x indicates a value. The model will learn to ignore or interpolate the smoking variable if input y indicates that it is missing. This behavior may be trained by including samples in the training in which the value is missing. Such samples can be obtained by masking the feature for that training iteration, or by using (client) training samples in which the value is missing in any case.

FIG. 2b schematically shows an example of an embodiment of a server training system 212. Server system 212 is similar to server system 211 except that Server system 212 does not comprise a feature weight determinator 240. Feature weights for the aggregated model are determined from feature weights received from the multiple clients. System 212 does comprise a training unit 231 and a base training set 210; these are advantageous as they ensure that the client systems start their training from a common starting point, which in turn ensures quicker convergence. However, this is not necessary, model parameters can also be directly averaged or a base model may be obtained from another source. System 212 comprises an evaluation unit 232 so that server 212 can be used to evaluate the model. Although convenient, this is also not necessary.

FIG. 3a schematically shows an example of an embodiment of a client training system 311. Client system 311 may be configured to cooperate with an embodiment of server 211. It will be understood that the client system 311 may be configured so as to operate as expected by an embodiment of the server system.

For example, client system 311 may comprise a client training set 310, e.g., in a client training set storage. It is an advantage that the client training set need not be shared with other parties. Client system 311 comprises model parameters 320. The model parameters may be obtained by training on the client training set. The model parameters may be obtained by receiving an initial base model. The model parameters 320 may be improved by locally training on the client training set. For example, the client may comprise a training unit 331 to execute a training algorithm, e.g., backpropagation, gradient descent, etc. Client system 311 may comprise an evaluation unit 332 for using the model. For example, evaluation unit 332 may use model parameters 320 to apply the model on a set of feature values. For example, the evaluation unit 332 may be used for the purposes of the client. For example, the evaluation unit 332 may be used to predict CVD risk for clients of a hospital.

Client device 311 may comprise a model update unit 322 to generate and send model updates to server 211. For example, a model update may be prepared periodically, or after a predetermined number of training iterations, or the like. A model update may comprise model parameters 320 or may comprise a delta, e.g., the difference between the last model as received from server 211 and the current values of the model parameters. Instead of model parameters, information indicating the gradient descent may be sent.

Client device 311 may comprise a feature weight determinator 340. Feature weight determinator 340 is configured to determine feature weights for the features that are used by the model device 311. The feature weights need only be computed for the features that are actually used by client device 311. For example, although a received model, e.g., a base model or an aggregated model may allow many features to be input to the model, part of these features, e.g., of the main features set, may not be represented in the client training set 310. Features for which client system 311 does not have training samples do not need feature weights determined for them, as no data is available for it. The client may use systems such as LIME or SHAP to compute feature weights. The client may also use other approaches, e.g., determine how often a model output changes if a particular input changes. For example, given n training samples, and a binary input x, then the feature weight of x may be computed as the percentage of training samples the change their output when x is replaced by it complement x̅.

FIG. 3b schematically shows an example of an embodiment of feature sets. Shown in FIG. 3b are feature sets 351, 352 and 353.

For example, feature set 351 may be the main feature set, e.g., the feature set for which the base model and/or aggregated model are configured. Shown in FIG. 3b for feature set 351 are features 361-364. Preferably, the base training set has some training data for each of the features, but this is not required. For example, during training of the base model the various techniques for missing feature values may be used. For example, the base training may be arranged so that features for which the base training set has no data have a low weight, e.g., close to 0. Once clients update the model, e.g., using data that does have information on said missing feature, the weight of the feature may move away from 0. Note that the computed weight for an un-unused, in an embodiment, converges to 0 if it were continued to be trained in a client which does not use said feature; however when the client reports its feature weights, it need not report the feature weight for the unused, feature. For example, it may set the feature weight to 0. For example, it may report the feature weight, but also indicate that it corresponds to an unused feature. This allows the server to average only over those clients that actually use the feature. The client may also report how many samples were used that use a particular feature—for an unused feature this number may be 0.

For example, a first client system may support the features of feature set 352, e.g., features 361, 362 and 364 but not 363. For example, a second client system may support the features of feature set 353, e.g., features 361, 362 and 363 but not 364. Note that feature sets 352 and 353 are overlap but are different. Note that feature sets 352 and 353 are both subsets of main feature set 351, in this case they are both strict subsets. Note, that both feature sets 352 and 353 miss at least one of the features in the main feature set. The client systems corresponding to feature sets 352 and 353 may use one of the techniques for missing feature values, e.g., for features 363 and 364 respectively. The client systems corresponding to feature sets 352 and 353 do not or need not determine feature weights for features 363 and 364 respectively.

Below a number of further examples are given. For example, systems 100, 200, 211, 212 and/or 311 may be configured for these examples. Note that these examples, contain specific choices that can be varied and/or that are not necessary. For example, an embodiment comprises the following elements:
1. Server: Train a base model on a base training set and distribute the base model to the clients
   a. The base model allows a main set of features as input, even if the base model may not use all of them or may not be trained for all of them. For example, from 20 to 30 features may be in the main feature set; more or fewer features is also possible.
   b. Missing feature values may be set to a substitute value, e.g., 0, e.g., an interpolated value, etc. or to a signal representing missing. Preferably, the effect of missing features on the prediction is neutralized.
   c. For example, not all features are necessarily represented in the base training data. The base collection might be small.
2. Client: Locally the base model is further trained on local training data
   a. Local training data may not use all features in the main feature set. For example, a client feature set may have from 10 to 20 features. The actual number may be larger or smaller, depending on the details of the use case.
   b. As for the server, missing features values may be dealt with in various way, e.g., set to a substitute value, set to missing, and so on.
   c. Local training data may use a feature from the main feature set that is not represented in the base training data. Local training data may use a feature from the main feature set that is used by some of the other client systems.
   d. The client sends a model update, indicating improved parameter values to the server.
3. Server: aggregate, e.g., average the received parameter updates and update the base model to an updated model.
4. Server: distribute the updated model to the clients
5. Client: Assess the updated model's features to establish which features are important.
   a. For example, apply the updated model to a multiple client training samples and perform an explanation for the resulting predictions.
   b. For example, input: x produces output y. By varying the values in x and observing the changes in y, the relative importance of the features in x are determined. This can be done for multiple inputs x. The inputs x can be selected from the client training set.
   c. Client will send the feature weights to the server.
   d. Alternatively, or in addition feature weights can be determined at the server, especially if the all features have representative training samples.
6. Server: Aggregate the received feature weights, e.g., by averaging thus obtaining global information on the relative importance of the features.
7. Server: communicate information obtained from the feature weights to the clients.
   a. For example, the server may send a signal to at least one of the multiple client devices in dependence on the aggregated feature weight for a feature of the aggregated model. For example, the server may send one or more or all aggregated feature weights. For example, the server may indicate which of the presently unused feature of a client are important for improving model outputs, e.g., improving predictions.
8. Steps 2-7 may be repeated multiple times.

For example, in an embodiment the model is a multivariate regression model, e.g., a linear multivariate regression model. This choice has the advantage that no base model is needed. For example, in an embodiment, the client trains a model on their client training sets, e.g., in effect, client base models. These models may be sent to the server who may aggregate them. For example, a main feature set may be established by taking the unit of the client feature sets. Parameters of the model may be obtained by a weighted average of the parameters of the clients that use the feature. A client may use the aggregated model by setting parameters to zero for unused features. Feature weights can be obtained directly from the parameters, e.g., by multiplying a parameter for a feature with an average value of the feature. For example, if a model parameter is high or the product of parameter and feature value average is high in the aggregate model but unused by a client, e.g., is 0, then this may be communicated. Instead of linear multivariate regression one may use logistic multivariate regression.

In an embodiment, the model is a medical model. The input to the model may be a tuple of medically relevant data, e.g., weight, age, height, smoking, diabetes, etc. The output may be a disease probability, e.g., a probability or likelihood that the corresponding patient has the disease or is at risk of developing the disease. The model may also be used for other purposes than prediction, e.g., image segmentation or classification, etc. For example, in an embodiment, the input to the model comprises multi-dimensional data, e.g., an image, e.g., obtained from an imaging device such as a camera, and multiple values of 1 or 0 dimensional data. For example, an image and in addition other medical data such as, age, blood pressure, smoking, diabetes and the like. The output of the model may be related to the image, e.g., an image segmentation or an image classification or the like. The additional non-image features may be disparate. For example, some client sites may or may not use the some or all of these features. Feature weight aggregation for the additional features may turn out that some of these are relevant for obtaining a correct output, others not so.

Aggregating models does not necessarily need to integrate the model updates into a single model, e.g., using federated learning or other decentralized learning algorithms. For example, in an alternative client models are collected in an ensemble model. For example, client models may be selected, e.g., models that perform well or that supplement each other well. For example, a first model for the ensemble may be selected as the best performing model; subsequent models may be selected as a model that performs well on training samples on which the present ensemble does not perform well. Adding models to the ensemble may be terminated when additional models no longer improves the prediction or when a predetermined performance has been reached, or both. Even if the base training set is large enough to allow assessing of good performance, there is still a benefit to local training, e.g., it prevents overfitting, e.g., it distributes computation, e.g., it avoids transmissions of large amounts of training data. Ensemble aggregation has the advantage that heterogenous models can easily be incorporated; for example, a neural network may be combined with a logistic multivariate model—in an embodiment, the models used by the client systems and server system are the same though, even if aggregated as an ensemble rather than integrated.

For example, in an embodiment, the server receives multiple trained models from multiple client systems, e.g., hospitals and creates an ensemble model from the multiple trained models. For example, an ensemble model may comprise a combining part; for example, the combining part may be trained to receive inputs from multiple models in the ensemble and to produce a single output. Statistical combinations are also possible. For example, an ensemble model may use AdaBoosting. For ensemble models one can compute feature weights as well. For example, a model agnostic explainer may be used, e.g., LIME, SHAP or the like, as this explainer do not need to assume a particular underlying model technology.

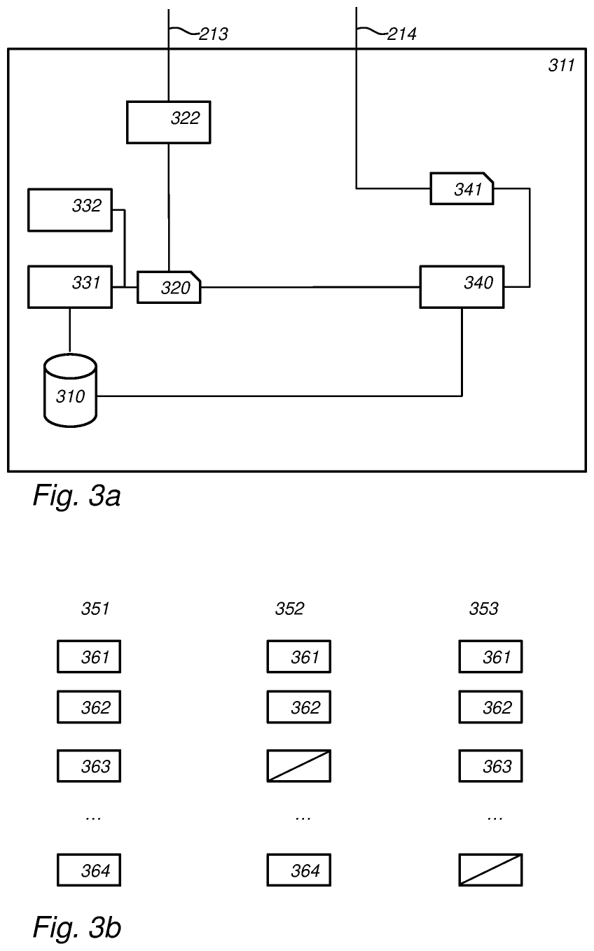

Yet further embodiments are illustrated with respect to FIGS. 4a and 4b. FIG. 4a schematically shows an example of an embodiment of a training system. Shown in FIG. 4a is a server 400, e.g., a server system or a server device, and multiple clients; shown are clients 421, 422 and 423.

Server 400 comprises various functions units, e.g., hardware and/or software configured for a function. For example, in an example, server 400 comprises a unit 411 for receiving aggregator packages. An aggregator package is received from a client device and comprises information that indicates how a previous iteration of the model may be improved with respect to local training data available at that client. Unit 412 is configured for an aggregated model. The model that is implemented in unit 412 is updated with the aggregator packages received from the clients. Unit 413 is configured as a model explainer. The model explainer determines for a current iteration of the model, which input features are important for its predictions. Unit 414 is configured as a feature distinguisher. The feature distinguisher determines what conclusion should be drawn from the model explainer's information and communicates to the clients. For example, the distinguisher may select a client that fails to use an important feature and communicate this information to the client. Unit 415 is configured to transfer a feature indication to a client. FIG. 4a shows information flowing from the clients to the server, e.g., model updates and client feature weights, and information flowing from the server to the clients, e.g., aggregated model and aggregated weights, or selected features.

For example, the embodiment may use Federated Learning. Federated Learning (FL) enables clients, e.g., hospitals, to collaboratively learn a shared prediction model without moving data outside the clients, e.g., hospitals. A model at each site learns on the features available at that particular site. The aggregated model is sent back to every client for further training. Explainable AI, e.g., methods and techniques in the application of artificial intelligence technology (AI) such that human experts can understand the results of the solution, may be used to determine the relative importance of the input features.

In decentralized scenarios, there is always the possibility that one or more features that are considered during training at one of the sites may be missing at other sites. There is a need to get rational recommendations for features considered in an aggregated model so that another site can start capturing important missing features.

Explainability algorithms may be applied to the aggregated model, such as obtained from Federated learning. Explainability algorithms may be used to interpret the model and determine the rationale behind a prediction determined in the aggregated model. Model performance can increase for clients that start to incorporate important but missed features, e.g., by capturing them. This may also reduce the time required to train a ta site.

When using federated learning and the like in a practical setting, problems are encountered. While federated learning allows decentralized learning it still requires uniform data across the clients. In practice, this is often not the case. In an embodiment, explainability techniques are used to interpret the model and extract important features captured in the final model. This knowledge can then be transferred to participated sites so that they can start capturing missing important features. This technique will not only increase model performance but will also reduce the time required to train at each site; training on a data set that allows predictions to be made easier takes less time. Thus, the possibility is addressed that features considered during training at one site may be missing at another.

The training at a site may involve a group of sites that participate in model training. Sites may be configured to send back updated gradients or weights, etc. after training locally. The server, also referred to as a coordinator server may be configured to manage the decentralized learning workflow and to coordinate with the sites. The coordinator server can be hosted as an on-premise server or in the cloud.

The sending of model updates, aggregated model, and client feature weights may be synchronized but this is not needed. In fact, especially when there are many clients, there is advantage in not having all clients participating in all steps or at the same time. For example, clients may send a model update when they have performed a sufficient amount of training to do so. Other clients may not yet be ready to send an update. When the server has a sufficient number of model update, it may prepare an aggregated model, without necessarily waiting for all the client to send an update. A model update received for a previous iteration of the model may still be integrated, e.g., weighted. When training is complete, a final model may be generated after the last round of training. This model can be stored on local disk or on cloud, etc.

The model explainer module may be used to interpret the model and to determine which features play an important role in the model predictions. Model explainer can be used to determine the importance of features. Model explainability is also known as model interpretability and give an aggregated view of the model performance. For example, it may help one to gain a better understanding why some of the model predictions are right while others are wrong, e.g., by tracing the model's decision path. The model explainer may give an overview about which features of the dataset have contributed to the decision taken by the model. The importance of a feature can be taken to be the influence it has on the model predictions. Based on the importance, suggestions can be provided to include the feature for sites which do not capture that particular feature. There are various known model explainers available like LIME, SHAP that can aid in interpretation of model decision.

For some models, e.g., a logistic regression model, one can obtain the coefficient or parameter as the feature importance score. The higher the score, the greater will be the importance associated with that feature and vice-versa. These coefficients give an overall idea of the feature importance for an entire dataset at a global level.

FIG. 4b schematically shows an example of an embodiment of a training system. Shown in FIG. 4b are two participating sites: sites 430 and 440, e.g., clients, there may be more participating sites. For example, the sites may each have a model for predicting Cardiovascular disease. Several risk prediction models of cardiovascular disease have been developed for different populations in the past decade, but to further improve models the participating sites, e.g., sites 430 and 440 want to cooperate to obtain a still better model. A Cardiovascular Disease Risk Prediction model can be trained on different sites using a federated learning algorithm.

Shown in FIG. 4b for each site are a client model 431, 441, e.g., a model received from a server but further trained on local data, a client prediction 432, 442, e.g., a prediction obtained by applying the client model to a local training sample and a client explainer 433, 443. The client explainer may use one or more of the predictions to determine feature weights 434, 444, e.g., LIME weights.

For example, feature weights 434 may be
40% Hypertension
10% Age
30% Diabetes
10% Exercise Regime
10% Family History

For example, feature weights 435 may be
25% Hypertension
25% Smoking
25% Diabetes
10% Age
5% Exercise Regime
10% Family History

Similar output can be generated after training locally on other sites. The feature weights 434 and 444 may be sent to an aggregator, e.g., server, for aggregation, possibly together with model updates. Multiple cycles of local training and aggregation may take place, until at some point a final model is obtained. For example, at a site 450, e.g., the server or one of site 430 or 440, yet a further site, a final aggregated model 451 may be available. If an explainer 453 is applied to predictions 452 to obtain feature weights 454, they may be different from the initial weights. For example, feature weights 454 may be
30% Hypertension
30% Smoking
10% Age
20% Diabetes
5% Exercise regime
5% Family history

Note that smoking was not used as feature by client 430. Note also that Family History which was inutility rated at 10%, has decreased to 5%. This is partly due to further training, but also due to the fact the Smoking has increased in importance. Site 430 may be advised to start capturing the Smoking feature as not using it will likely impair the predictive power of the model at site 430.

In the various embodiments of a server system and a client system, e.g., systems 200 and 100, etc. the communication interfaces may be selected from various alternatives. For example, the interface may be a network interface to a local or wide area network, e.g., the Internet, a storage interface to an internal or external data storage, an application interface (API), etc. These systems may have a user interface, which may include well-known elements such as one or more buttons, a keyboard, display, touch screen, etc. The user interface may be arranged for accommodating user interaction for configuring the systems, training the networks on a training set, or applying the system to new data, etc.

Storage may be implemented as an electronic memory, say a flash memory, or magnetic memory, say hard disk or the like. Storage may comprise multiple discrete memories together making up storage 160, 260. Storage may comprise a temporary memory, say a RAM. The storage may be cloud storage. Server system and client system may each be implemented in a single device.

For example, in an embodiment the client systems are client devices while the server system is implemented in the cloud, e.g., distributed across multiple computers. Typically, the server system and client system comprise a microprocessor which executes appropriate software stored at the system; for example, that software may have been downloaded and/or stored in a corresponding memory, e.g., a volatile memory such as RAM or a non-volatile memory such as Flash. Alternatively, the systems may, in whole or in part, be implemented in programmable logic, e.g., as field-programmable gate array (FPGA). The systems may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, server system and client system may comprise circuits for the evaluation of models, e.g., neural networks.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

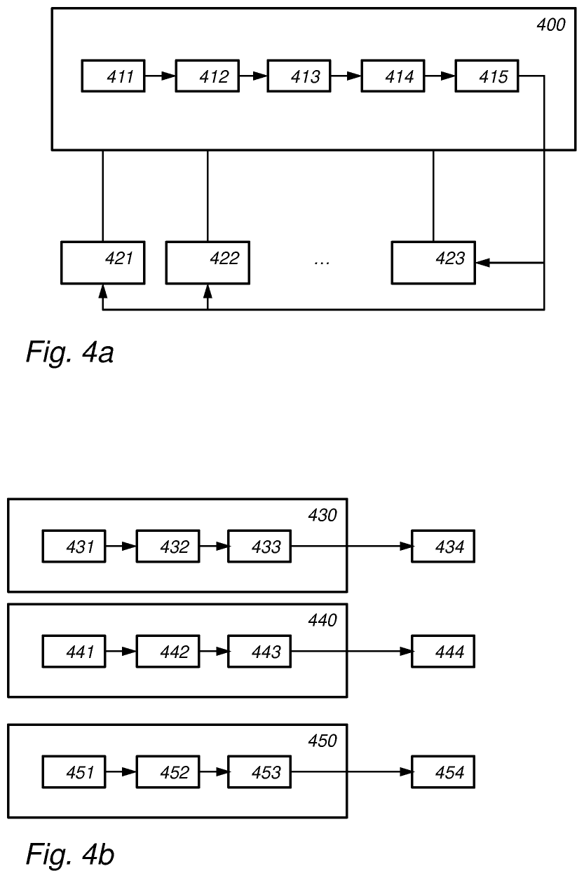

FIG. 5 schematically shows an example of an embodiment of a server training method 500. Method 500 may be a computer-implemented training method for training a model. Method 500 comprises
receiving (510) multiple model updates from multiple client devices, a model update representing model parameters improved in training iterations executed by a client device on a corresponding client training set, a training sample in a client training set indicating values for multiple features, at least some of the multiple client training sets indicating values for different features,
aggregating (520) the multiple model updates to obtain an aggregated model, the aggregated model being arranged to receive multiple feature values representing multiple features,
obtaining feature weights (530) for the aggregated model representing a relative importance of the multiple features for the aggregated model's output, sending a signal (540) to at least one of the multiple client devices in dependence on the aggregated feature weight for a feature of the aggregated model.

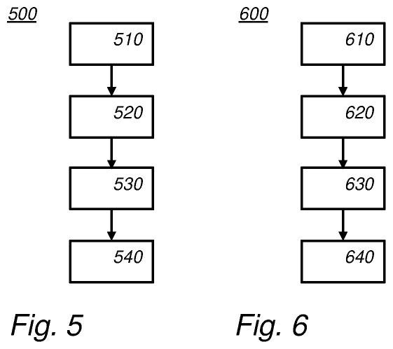

FIG. 6 schematically shows an example of an embodiment of a client training method 600. Method 600 may be computer-implemented. Method 600 comprises
improving (610) model parameters in training iterations executed on a client training set, a training sample in a client training set indicating values for multiple features, at least some of the other client training sets indicating values for different features,
sending (620) a model update representing the improved model parameters to a training system, wherein the method further comprises, wherein the model further comprises
receiving (630) an aggregated model from the training system and determining client feature weights for the aggregated model and sending the client feature weights to the training system, and/or
receiving (640) a signal indicating a particular feature not indicated in the client training set, wherein the client training set does not indicate values for the particular feature and a relative importance of the particular feature is above a threshold.

For example, a training method may be computer implemented method. For example, accessing training data, and/or receiving model updates, client feature weights, sending aggregated data, sending feature related data may be done using a communication interface, e.g., an electronic interface, a network interface, etc. For example, storing or retrieving parameters may be done from an electronic storage, e.g., a memory, a hard drive, etc., e.g., parameters of the networks. For example, applying a neural network to data of the training data, and/or adjusting the stored parameters to train the network may be done using an electronic computing device, e.g., a computer.

A neural network, either during training and/or during applying may have multiple layers, which may include, e.g., convolutional layers and the like. For example, the neural network may have at least 2, 5, 10, 15, 20 or 40 hidden layers, or more, etc. The number of neurons in the neural network may, e.g., be at least 10, 100, 1000, 10000, 100000, 1000000, or more, etc.

Many different ways of executing the method are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

Embodiments of the method may be executed using software, which comprises instructions for causing a processor system to perform method 500 or 600. A system method may comprise all or part of methods 500 and 600. Methods 500 and 600 may be extended by some of the options discussed herein. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the devices, units and/or parts of at least one of the systems and/or products set forth.

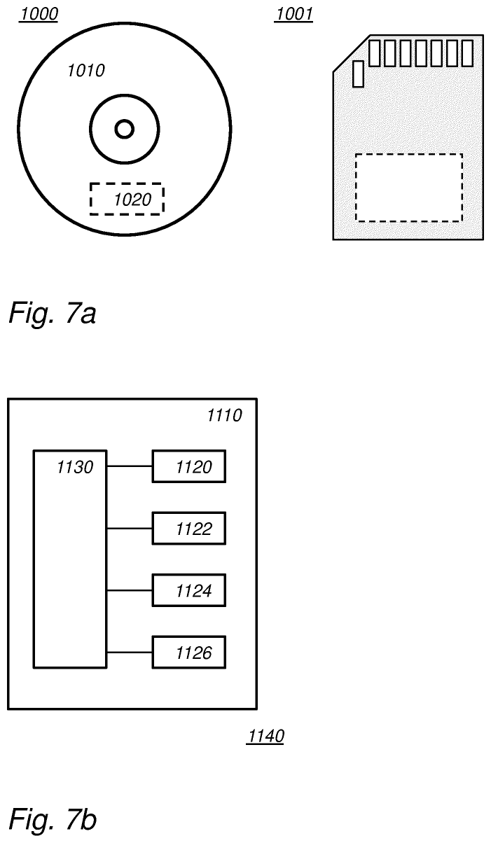

FIG. 7a shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of a server or client method, according to an embodiment. The computer program 1020 may be embodied on the computer readable medium 1000 as physical marks or by magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said server or client method.

FIG. 7b shows in a schematic representation of a processor system 1140 according to an embodiment of server or client system. The processor system comprises one or more integrated circuits 1110. The architecture of the one or more integrated circuits 1110 is schematically shown in FIG. 7b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., the server or client device may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

While device 1140 is shown as including one of each described component, the various components may be duplicated in various embodiments. For example, the processor 1120 may include multiple microprocessors that are configured to independently execute the methods described herein or are configured to perform steps or subroutines of the methods described herein such that the multiple processors cooperate to achieve the functionality described herein. Further, where the device 1140 is implemented in a cloud computing system, the various hardware components may belong to separate physical systems. For example, the processor 1120 may include a first processor in a first server and a second processor in a second server.

It should be noted that the above-mentioned embodiments illustrate rather than limit the presently disclosed subject matter, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In the device claim enumerating several parts, several of these parts may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A computer-implemented server method for training a model, the method comprising
receiving multiple model updates from multiple client systems, a model update representing model parameters improved in training iterations executed by a client system on a corresponding client training set, a training sample in a client training set indicating values for multiple features, at least some of the multiple client training sets indicating values for different features,
aggregating the multiple model updates to obtain an aggregated model, the aggregated model being arranged to receive multiple feature values representing multiple features,
obtaining feature weights for the aggregated model representing a relative importance of the multiple features for the aggregated model's output,
sending a signal to at least one of the multiple client systems in dependence on the aggregated feature weight for a feature of the aggregated model.

2. A training method as in claim 1, wherein the aggregated model is arranged to receive as input feature values for a main feature set, a training sample in a client training set indicating values for multiple features, said multiple features being a subset of the main feature set, at least one client training set indicating feature values for features that are a strict subset of the main feature set.

3. A training method as in any one of the preceding claim 1, comprising
selecting a particular feature and a client training set, wherein the client training set does not indicate values for the particular feature and the relative importance of the particular feature is above a threshold,
sending the signal comprises sending a signal to the client system corresponding to the selected client training set indicating the particular feature.

4. A training method as in claim 1, comprising distributing the aggregated model to the multiple client systems.

5. A training method as in claim 4, wherein obtaining feature weights for the aggregated model comprises receiving multiple client feature weights for the aggregated model determined by multiple clients and aggregating the client feature weights.

6. A training method as in claim 5, wherein an aggregated feature weight is determined from the multiple client feature weights for which the corresponding client training set indicates values for the aggregated feature weights.

7. A training method as in claim 1, wherein obtaining feature weights comprises
for multiple training samples
applying the aggregated model to feature values in a training sample obtaining a model output,
applying an explainability algorithm to obtain sample feature weights indicating the relative importance of the feature values for the training sample,
combining the sample feature weights to obtain the feature weights.

8. A training method as in claim 1, comprising
training a base model on a base training set and distributing the trained base model to the multiple client systems, the model updates being updates of the base model, the base model being arranged to receive feature values for a main set of features, a training sample in a client training set indicating values for multiple features, said multiple features being a subset of the main feature set.

9. A training method as in claim 7, wherein
the training sample is a training sample in the client training set, and/or
the training sample is a training sample in the base training set.

10. A training method as in claim 1, comprising
one or more iterations of
receiving multiple model updates from multiple client systems with respect to an aggregated model received by the client system,
aggregating the multiple model updates to obtain a further aggregated model,
obtaining feature weights for the further aggregated model.

11. A training method as in claim 1, wherein the model is arranged for applying the model to a training sample indicating values for multiple features and not indicating a value for at least one missing feature, wherein applying the model comprises
inputting an interpolated value for the missing feature, and/or
inputting a signal indicating no feature value is indicated for a feature.

12. A training method as in claim 1, wherein aggregating the multiple model updates comprises
applying an average to the multiple model updates, and/or
selecting two or more of the multiple model updates and configuring an ensemble model from the selected model updates.

13. A training method as in claim 1, wherein the model is a medical model arranged to receive medical feature values as input and/or to predict a medical condition.

14. A computer-implemented client method for training a model, the method comprising
improving model parameters in training iterations executed on a client training set, a training sample in a client training set indicating values for multiple features, at least some of the other client training sets indicating values for different features,
sending a model update representing the improved model parameters to a training system, wherein the method further comprises, wherein the model further comprises
receiving an aggregated model from the training system and determining client feature weights for the aggregated model and sending the client feature weights to the training system, and/or
receiving a signal indicating a particular feature not indicated in the client training set, wherein the client training set does not indicate values for the particular feature and a relative importance of the particular feature is above a threshold.

15. A server system for training a model comprising, the server system comprising
a communication interface configured for digital communication with multiple client systems,
a processor system configured for
receiving multiple model updates from multiple client systems, a model update representing model parameters improved in training iterations executed by a client system on a corresponding client training set, a training sample in a client training set indicating values for multiple features, at least some of the multiple client training sets indicating values for different features,
aggregating the multiple model updates to obtain an aggregated model, the aggregated model being arranged to receive multiple feature values representing multiple features,
obtaining feature weights for the aggregated model representing a relative importance of the multiple features for the aggregated model's output, and
sending a signal to at least one of the multiple client systems in dependence on the aggregated feature weight for a feature of the aggregated model.

16. A client system for training a model, the client system comprising
a communication interface configured for digital communication with a server system, and
a processor system configured for
improving model parameters in training iterations executed on a client training set, a training sample in a client training set indicating values for multiple features, at least some of the other client training sets indicating values for different features,
sending a model update representing the improved model parameters to a training system, wherein the method further comprises, wherein the model further comprises
receiving an aggregated model from the training system and determining client feature weights for the aggregated model and sending the client feature weights to the training system, and/or
receiving a signal indicating a particular feature not indicated in the client training set, wherein the client training set does not indicate values for the particular feature and a relative importance of the particular feature is above a threshold.

17. A transitory or non-transitory computer readable medium comprising data representing instructions, which when executed by a processor system, cause the processor system to perform the method according to claim 1.
